(19) United States
(12) Patent Application Publication
(10) Pub. No.: US 2009/0171961 A1
(43) Pub. Date: Jul. 2, 2009

(54) Workflow collaboration in a forensic investigations system

(76) Inventor: Jason Fredrickson, Pasadena, CA (US)

Correspondence Address: CHRISTIE, PARKER & HALE, LLP, PO BOX 7068, PASADENA, CA, 91109-7068, US

(21) Appl. No.: 12/005,695

(22) Filed: Dec. 28, 2007

(51) Int. Cl. G06F 17/30

(52) U.S. Cl. 707/7; 707/E17.059

(57) ABSTRACT

A system and method for centralized workflow collaboration that invokes the skills of different experts to carry out investigation of forensic evidence data and generate a forensic report. A centralized workflow system stores attributes, annotations, reports, and other information associated with collected forensic evidence data. The attributes associated with the evidence data are used to narrow the evidence data without actually reviewing the contents of the evidence, and to assign the review of the contents of the narrowed evidence to experts who are deemed to have the qualifications necessary to perform the review. The assignment of a workflow task to a particular expert may be manual or automatic. The generating of workflow tasks may also be automatic in response to evidence processing.

### FIELD OF THE INVENTION

This invention relates generally to a system and method for analyzing forensic evidence data, and more particularly, to a system and method for centralized workflow collaboration for analyzing the evidence data.

### BACKGROUND OF THE INVENTION

The analysis of forensic evidence data often requires the participation of different experts in different fields who can contribute to the investigation process based on the skill set of the different experts. For example, when investigating evidence data collected from an individual's computer who is suspected for tax evasion, a forensic investigator may be invoked to review data stored in different parts of the computer's hard drive and identify the files (e.g. all spreadsheets) that may contain information of interest. A fraud investigator may then be invoked to review the contents of the identified files. After his or her review, the fraud investigator may request the forensic investigator to do additional searches of the hard drive based on the results of his or her analysis. The fraud investigator may also want to make notes in association with certain files for including into a forensic report, and/or require other interactions with the forensic investigator.

Currently, there is no centralized system that efficiently allocates the review tasks to different experts based on their skill sets and that allows these experts to collaborate with one another to effectuate investigation of evidence data. For example, current mechanisms of forensic investigation generally require the pieces of evidence that have been identified by a forensic investigator as being of interest to be exported and stored in a portable medium or printed on paper for delivering to another expert for his review based on his expertise. Data generated by the expert from the review of the pieces of evidence may similarly be stored in a portable medium or printed on paper, and provided to the forensic investigator. The forensic investigator may then generate a forensic report that includes the data provided by the different experts. Thus, under current forensic investigation systems, each expert processes evidence data locally and independently of others, and generates results based on such processing. The independently generated results are then compiled and correlated for ultimately providing a forensic investigations report.

Accordingly, what is desired is a system and method that allows different experts involved in a forensic investigation to collaborate with one another from a centralized system to efficiently conduct different types of analyses of evidence data.

### SUMMARY OF THE INVENTION

According to one embodiment, the present invention is directed to a computer-implemented method for analyzing forensic evidence data. The method is implemented by a workflow server that includes a processor and a memory operably coupled to the processor and having program instructions stored therein, where the processor is operable to execute the program instructions.

According to one embodiment of the invention, the workflow server receives a plurality of evidence pieces. Each of the plurality of evidence pieces has a plurality of attributes stored in association with the evidence piece. The workflow server filters the plurality of evidence pieces based on a filter criteria that includes one or more of the plurality of the attributes. The workflow server then receives a first user command for the filtered evidence pieces from an investigation computer, and generates a separate workflow item for each of the filtered evidence pieces in response to the first user command. The workflow server also receives a second user command for the workflow items, and identifies an expert based on the second user command. The identified expert is a person or thing that has abilities commensurate with the filter criteria. Each of the workflow items is assigned to the identified expert for prompting analysis of contents of the filtered evidence pieces.

According to one embodiment of the invention, the attributes are metadata information.

According to one embodiment of the invention, the filtering of the evidence pieces does not invoke examination of contents of the evidence pieces.

According to one embodiment of the invention, the workflow server maintains an expert list in association with each of the plurality of attributes, identifies the expert list associated with the filter criteria, and identifies a person from the expert list for assigning the workflow items to the identified person.

According to one embodiment of the invention, the workflow server generates annotations for one or more of the filtered evidence pieces for which a workflow item has been generated, generates labels for the annotations, and stores the annotations and the labels in association with the one or more of the filtered evidence pieces. The annotations may include notes generated based on the analysis of the contents of the one or more of the filtered evidence pieces.

According to one embodiment of the invention, the workflow server filters the plurality of evidence pieces based on a second filter criteria for generating second filtered evidence pieces, where the second filter criteria includes one or more of the labels generated for the annotations. A second workflow item is generated for each of the second filtered evidence pieces, and each of the generated second workflow items are assigned to a second expert selected based on the second filter criteria for prompting analysis of the contents of the corresponding second filtered evidence pieces.

According to one embodiment of the invention, one or more of the annotations are identified based on the associated labels, and a report generated based on the identified annotations.

According to one embodiment of the invention, the workflow server tracks status of each of the workflow items, and displays the status on a user display.

According to one embodiment, the present invention is directed to a computer-implemented method for automatic workflow task generation in a forensic investigation system. The method includes processing a piece of evidence and generating a trigger event based on the processing of the piece of evidence. A rule set is automatically invoked based on the generated trigger event. One or more evidence pieces are automatically selected, without user intervention, based on the invoked rule set. A separate workflow item is automatically generated, without user intervention, for each of the one or more of the evidence pieces, and an expert automatically selected, without user intervention, based on the invoked rule set. Each of the generated workflow items are then automatically assigned, without user intervention, to the selected expert.

According to one embodiment of the invention, the piece of evidence is associated with a plurality of attributes. The processing of the piece of evidence includes reviewing the plurality of attributes stored in association with the piece of evidence, and the trigger is identification of a particular one of the plurality of attributes.

According to one embodiment of the invention, the one or more evidence pieces includes the processed piece of evidence.

According to one embodiment of the invention, the one or more evidence pieces includes evidence pieces other than the processed piece of evidence.

According to one embodiment of the invention, the automatically selecting an expert includes maintaining an expert list in association with each of the plurality of attributes; identifying the expert list associated with the particular one of the plurality of attributes; and identifying an expert from the expert list.

According to one embodiment of the invention, the processing of the piece of evidence includes generating an annotation for the piece of evidence; and generating a label for the annotation, wherein the trigger event is the generating of the annotation having the label.

According to one embodiment of the invention, the rule set identifies a filter criteria, and the automatically selecting the one or more evidence pieces is based on the filter criteria.

According to one embodiment of the invention, the filter criteria identifies one or more of a plurality of attributes associated with the one or more other evidence pieces.

According to one embodiment of the invention, the automatically selecting an expert includes maintaining an expert list in association with each of the plurality of attributes, identifying the expert list associated with the filter criteria, and identifying an expert from the expert list.

According to one embodiment of the invention, the identified expert has abilities commensurate with the filter criteria.

According to one embodiment of the invention, the automatically selecting does not invoke examination of contents of the one or more other evidence pieces.

It should be appreciated, therefore, that the present system and method allows efficient allocation of the review of evidence data to experts who are qualified to do the review. The review occurs from a centralized location, allowing any data generated from the review to be easily correlated with the reviewed evidence to trigger further searches of the evidence and/or for report generation.

### BRIEF DESCRIPTION OF THE DRAWINGS

FIG. 1 is a block diagram of a workflow collaboration system according to one embodiment of the invention;

FIG. 2 is a photographic image of a screen displaying a directory of evidence files (folders) collected by an evidence collector according to one embodiment of the invention;

FIG. 3A is a photographic image of a screen for browsing information stored in an exemplary evidence file;

FIG. 3B is a photographic image of an exemplary search screen where a user may indicate a particular keyword in a search field;

FIG. 4 is a task window provided by a workflow server in response to a command to generate a new task according to one embodiment of the invention;

FIG. 5 is a photographic image of a screen displaying information about different tasks assigned to a particular expert according to one embodiment of the invention;

FIG. 6 is a photographic image of a plurality of workflow items assigned to a particular expert according to one embodiment of the invention;

FIG. 7 is a photographic image of an annotation generated upon review of contents of an exemplary piece of evidence according to one embodiment of the invention;

FIG. 8 is a photographic image of a window displaying a list of annotations according to one embodiment of the invention;

FIG. 9 is a photographic image of a forensic report generated according to one embodiment of the invention;

FIG. 10 is a flow diagram of a process for analyzing evidence data according to one embodiment of the invention;

FIG. 11 is a more detailed flow diagram of a process for filtering evidence pieces based on specific filter criteria according to one embodiment of the invention;

FIG. 12 is a more detailed flow diagram of a process for assigning workflow items to an expert according to one embodiment of the invention; and

FIG. 13 is a flow diagram of a process executed by the automatic task generation module in automatically generating tasks according to one embodiment of the invention.

### DETAILED DESCRIPTION

In general terms, embodiments of the present invention are directed to a system and method for centralized workflow collaboration that invokes the skills of different experts to carry out investigation of forensic evidence data and generate a forensic report. In this regard, a centralized workflow system is provided which is coupled to a central database that stores attributes, annotations, reports, and other information associated with collected forensic evidence data. The attributes (also referred to as metadata) associated with the evidence data are used to narrow the evidence data without actually reviewing the contents of the evidence, and to assign the review of the contents of the narrowed evidence to experts who are deemed to have the qualifications necessary to perform the review.

According to one embodiment of the invention, a workflow task is generated for a particular expert based on the one or more pieces of evidence narrowed from an unanalyzed evidence set. The workflow task includes one or more workflow items, where each workflow item is assigned to a particular piece of narrowed evidence. The workflow task is assigned to an expert who is determined to have the skill sets needed to analyze the contents of the evidence pieces assigned to the expert. For example, the expert may be a translator whose skill set is to translate documents from a foreign language to English. In another example, the expert may be a fraud investigator whose skill set is to understand financial information and detect fraud. A person of skill in the art should recognize that various experts may be invoked at the same time to carry out their portion of the forensic investigation by using their skill sets to analyze the pieces of evidence assigned to them.

According to one embodiment of the invention, the assignment of a workflow task to a particular expert is manual, where a user manually identifies the narrowed pieces of evidence as well as the expert who is to analyze the pieces of evidence, and manually creates a workflow item for that expert. According to another embodiment of the invention, the assignment of the workflow task is automatic based on a predetermined rule set which automatically narrows the pieces of evidence to be analyzed, and/or automatically creates workflow items for experts who have the necessary skill sets to perform the analysis.

Experts access the centralized workflow system for viewing, fulfilling, or otherwise responding to workflow tasks that have been assigned to them. In tending to a workflow item contained in a task assigned to a particular expert, the expert reviews the contents of the evidence associated with the workflow item. The expert may then create annotations containing notes and other information for the useful pieces of evidence, and store the annotations in the central database in association with the reviewed pieces of evidence. For example, the annotation may include an English translation of a piece of evidence, or include comments about particular financial transactions found in the piece of evidence. The annotations are then added to the central database and become part of evidence that may be searched and filtered. In this regard, the annotations are associated with one or more labels that characterize the annotations and/or analyzed evidence. The annotations and associated labels become extensions of the analyzed pieces of evidence, and may be used to further search and filter other useful pieces of evidence.

Although the experts selected for the review of the contents of filtered evidence pieces are described mainly as human experts, a person of skill in the art should recognize that the experts may take the form of specialized computer applications configured to perform electronic analyses of the contents of the assigned pieces of evidence. For example, the expert may be a translation software that automatically translates a given document into English, an antivirus vendor that automatically determines whether or not a given application is malware, a natural language “reader” that searches for semantic meaning, a steganographic data decoder, or any like device conventional in the art. Thus, the present embodiments are not limited to only human experts.

### I. Workflow Collaboration System

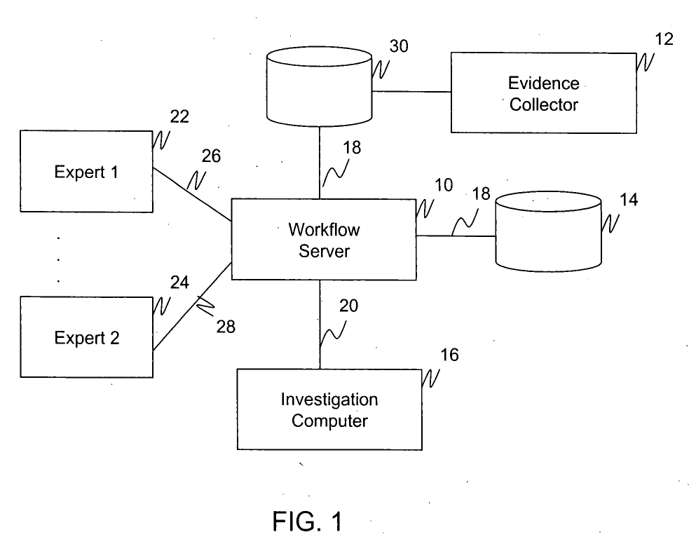

FIG. 1 is a block diagram of a workflow collaboration system according to one embodiment of the invention. The system includes a workflow server 10 coupled to an evidence database 14 and a raw evidence store 30 via a communications link 18. The communications link 18 may be a direct wire, an infrared data port, a wireless communications link, global communications link such as the Internet, or any other communications medium known in the art. The evidence database 14 and raw evidence store 30 may be hosted in mass storage devices such as disk drives or drive arrays. The evidence database 14 stores attributes, annotations, reports, and the like (collectively referred to as a evidence data) in association with evidence collected by an evidence collector 12. The evidence collector 12 may be any computer device configured to collect evidence data from any target device according to any mechanism known in the art. For example, the evidence collector 12 may host an investigative tool marketed as EnCase® by Guidance Software, Inc., of Pasadena, Calif. According to one embodiment of the invention, evidence collected by the evidence collector 12 is uploaded to the raw evidence store 30 in order to conduct analysis of the uploaded evidence. In this manner, the raw evidence store 30 stores the raw, collected evidence data separate from the evidence data in the evidence database 14.

The workflow server 10 is further coupled to one or more investigation computers 16 over a communications link 20, which may be similar to the communications link 18. According to one embodiment of the invention, the investigation computer 16 transmits to the workflow server 10 commands for uploading particular evidence files from the evidence collector 12 into the raw evidence data store 30, commands for filtering the pieces of evidence contained in the evidence files based on one or more filter criteria, and commands for generating a workflow task for the filtered pieces of evidence. Commands may also be transmitted by the investigation computer 16 to generate investigation reports.

The generated workflow tasks are assigned to one or more experts having access to expert computers 22, 24. The expert computers 22, 24 are coupled to the workflow server over communications links 26, 28 which may be similar to the communications links 18, 20. According to one embodiment of the invention, the experts access the workflow server 10 to execute the workflow tasks assigned to them by the server. In this regard, each expert computer retrieves an assigned piece of evidence from the workflow server and displays or otherwise outputs contents of the evidence on a terminal or some other output device coupled to the expert computer. Upon review of the evidence by the expert, the expert may direct the expert computer to generate an annotation for the reviewed evidence if the evidence contains useful information. The generated annotation is uploaded to the workflow server 10 and stored in the evidence database 14 in association with the analyzed evidence data.

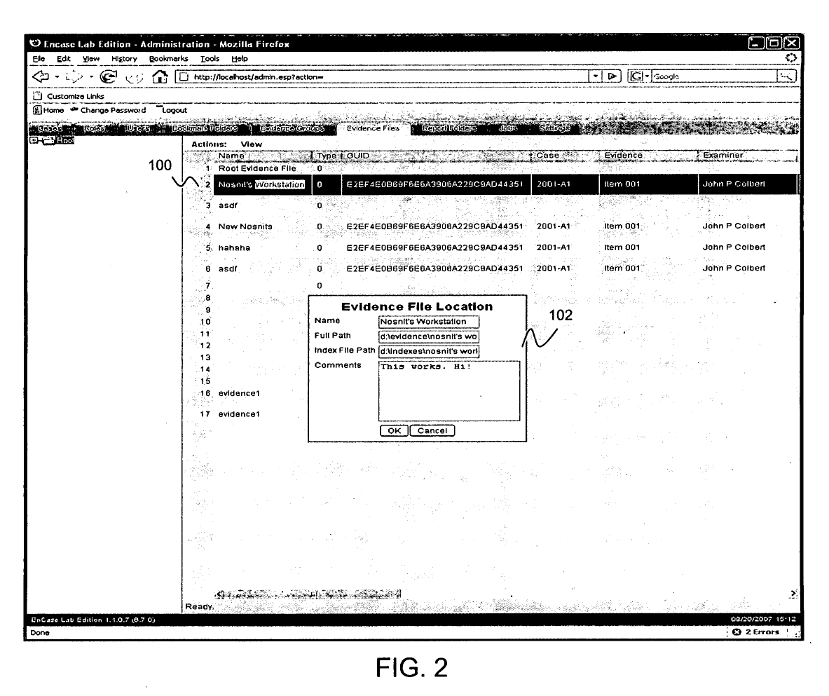

FIG. 2 is a photographic image of a screen displaying a directory of evidence files (folders) collected by the evidence collector 12 according to one embodiment of the invention. Each evidence file 100 is a container for different pieces of evidence collected by the evidence collector from a target device. According to one embodiment of the invention, the evidence collector 12 provides a graphical user interface for selecting and uploading to the workflow server one or more evidence files to be analyzed.

According to one embodiment of the invention, once an evidence file is uploaded to the workflow server 10, the investigation computer 16 provides commands identifying the evidence pieces that have a desired attribute. Alternatively, the investigation computer 16 provides a filter criteria and the workflow server automatically identifies the evidence pieces that have the desired attribute based on the filter criteria.

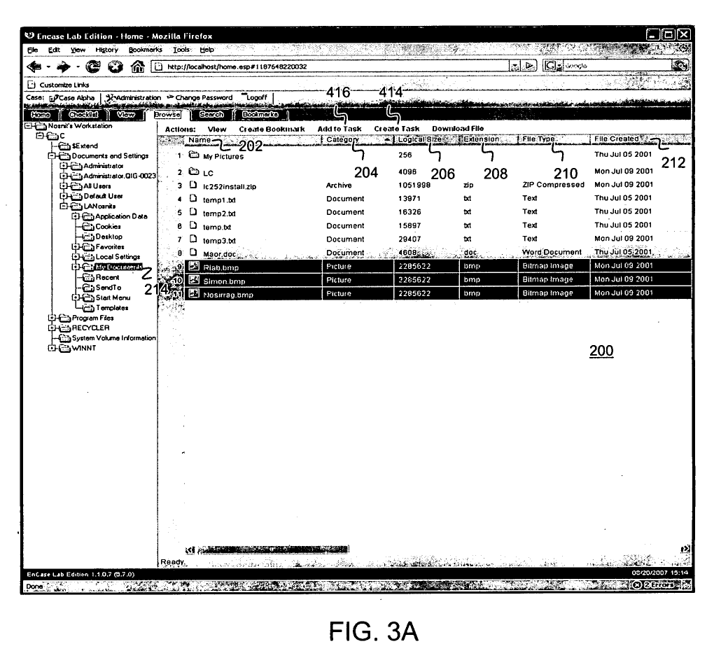

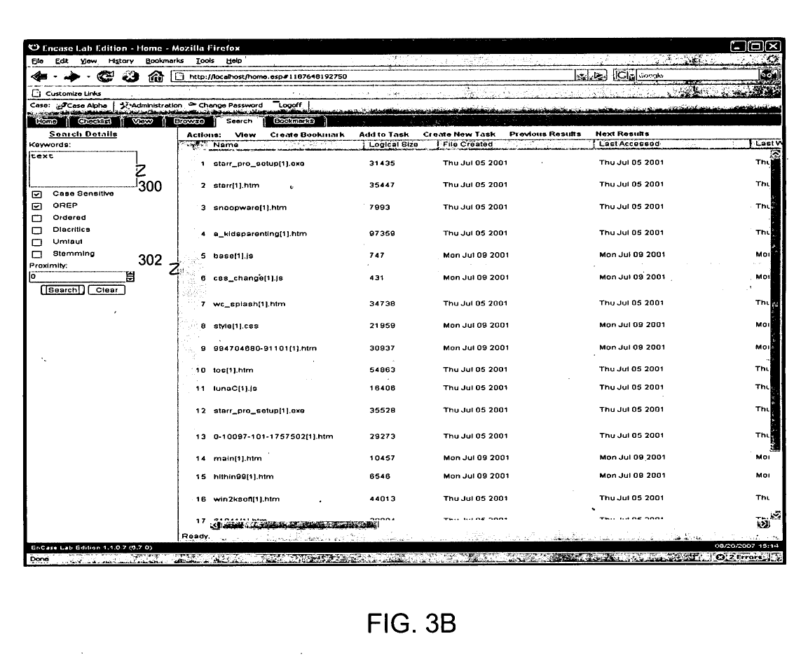

FIG. 3A is a photographic image of a screen for browsing and identifying the desired evidence pieces in an exemplary evidence file. In the illustrated example, the evidence file contains a disk image of a hard drive in “Nosnit's Workstation.” Selection of a “My Documents” folder 214 of the evidence file causes the workflow server 10 to display the evidence pieces stored in this folder. In this regard, filter criteria is the selected folder which is provided to the workflow server to filter and display the evidence pieces located in this folder in window 200.

Different attributes associated with the evidence pieces located in the selected folder are correlated and displayed in different fields of the window 200. For example, a name of the piece of evidence may be displayed in a name field 202. A general category in which the evidence piece is categorized, such as, for example, an archive, a document, a picture, and the like, may be displayed in a category field 204. A logical size, file extension, file type, and file creation dates may be respectively displayed in a logical size field 206, an extension field 208, a file type field 210, and a creation date field 212. The displayed evidence pieces may further be filtered by highlighting files whose attributes match a particular filter criteria, such as, for example, all picture files. The highlighting may be in response to a command by the investigation computer 16.

Although the illustrated example provides some examples of attributes that may be associated with the pieces of evidence to be analyzed, a person of skill in the art should recognize that the present invention is not limited to only these types of attributes. In fact, any other metadata information may be used to filter evidence pieces that may be of interest for a current forensic investigation. For example, a particular file hash number may be identified as a filter criteria for filtering all documents associated with the particular hash number. A person of skill in the art should also recognize that the filtering of the evidence may be based on a single attribute, or a combination of various attributes.

According to one embodiment of the invention, instead of manually browsing through the evidence file in search of evidence pieces having a particular attribute, such evidence pieces may be automatically displayed by invoking a search and retrieval routine on the workflow server. According to one embodiment of the invention, the investigation computer 16 transmits a keyword or keyword phrase that identifies one or more attributes, and the workflow server automatically searches for attributes associated with the keyword or keyword phrase. The workflow server then displays the evidence pieces having attributes that match the keyword. The submitted keyword or keyword phrase, therefore, acts as a filter criteria.

According to another embodiment of the invention, the keyword is used to automatically search the contents of the evidence pieces. In this regard, a full text index of the documents being searched is invoked for determining which document includes the keyword. The identified documents are then filtered out. According to yet another embodiment of the invention, the filtering process filters based on both contents and metadata (i.e. attributes).

FIG. 3B is a photographic image of an exemplary search screen where a user may indicate a particular keyword in a search field 300. In response to the keyword, the workflow server searches the evidence pieces that either contain the keyword and/or which attributes are identified by the keyword, and displays such evidence pieces in a window 302. All or a portion of such filtered evidence pieces may then be selected for generating a workflow task.

According to one embodiment of the invention, upon the filtering of the desired evidence pieces based on their attributes, the investigation computer 16 transmits a command to generate a workflow task for the filtered pieces of evidence upon user actuation of a “create task” button 414 (FIG. 3A). The filtered evidence pieces may also be added to an existing task upon selection of an “add to task” button 416 (FIG. 3A). In another embodiment of the invention, the specified keyword phrase instructs the workflow server to generate a workflow task for the filtered pieces of evidence, and the user need not manually actuate the “create task” button 414.

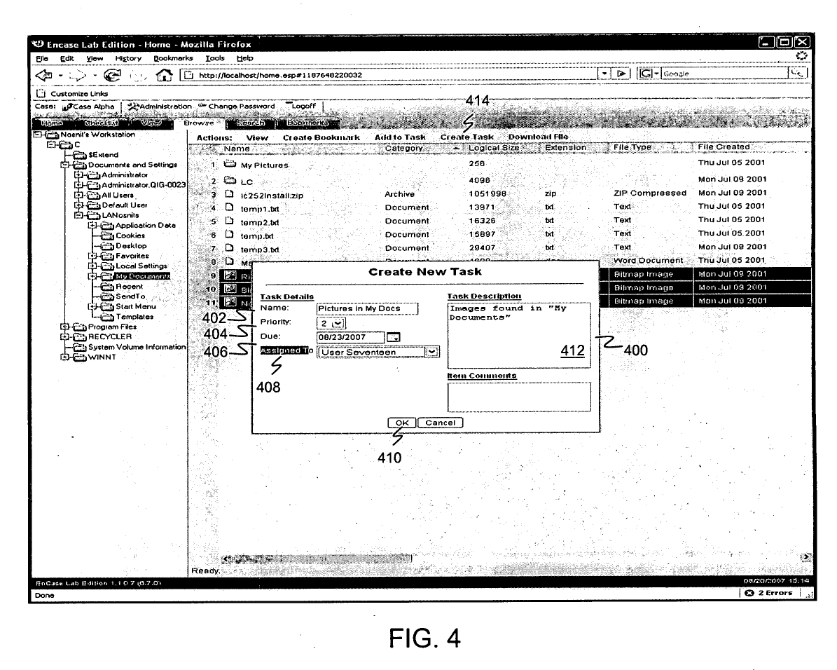

FIG. 4 is a task window 400 provided by the workflow server 10 in response to the command to generate a new task according to one embodiment of the invention. The task window allows the investigation computer to specify various task details such as, for example, a task name 402, a priority level 404, and a due date 406. The workflow server 10 may also select an expert in field 408 and assign the task to the expert. The expert may be selected in response to a manual designation by an investigator via the investigation computer. In this regard, the evidence database 14 includes one or more lists of experts that may be manually selected and assigned to a particular task. Each expert list may be associated with a filter criteria used to filter the evidence pieces.

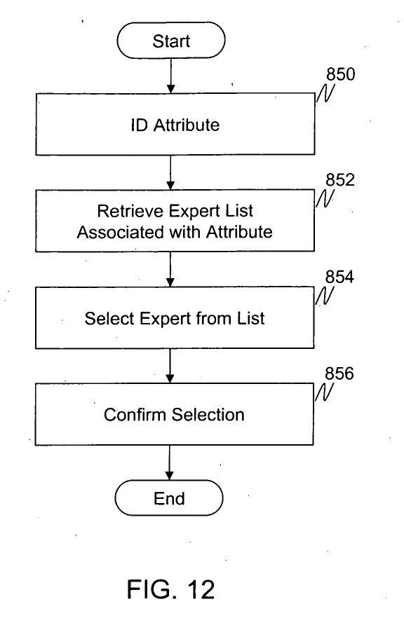

According to another embodiment of the invention, the expert may be automatically selected based on expert selection rules invoked by the workflow server as is described in further detail below with respect to FIG. 12. In either embodiment, the selected expert is one who has a skill set commensurate with the filter criteria. For example, an expert who speaks French may be selected based on the fact that a “French” filter criteria was used to filter the evidence. This helps ensure that the experts who have the necessary skills to review the contents of a particular piece of evidence spend their time and effort in doing the review.

A task description area 412 allows a user to enter a description of the analysis that is to be undertaken by the expert to whom the task is assigned. For example, the task may be to translate the associated evidence into English, or any other analysis that makes use of the expert's skills for a current forensic investigation.

Actuation of an OK button causes the newly generated task to be uploaded to the workflow server 10. According to one embodiment of the invention, the task information is bundled with identifiers of the filtered evidence pieces to which the task relates, and the bundled information transmitted to the workflow server.

The workflow server 10 receives the newly generated task and information on the associated filtered evidence pieces, and proceeds to assign the task to the indicated expert. In this regard, the workflow server 10 generates a separate workflow item for each evidence piece that is associated with the task, and stores the task and generated workflow items in association with the indicated expert. According to one embodiment, a workflow item is a checklist item that prompts action from the expert, and which may be tracked and monitored by the workflow server 10, expert computer 22, 24, and/or investigation computer 16. For example, a workflow item may be to translate the piece of evidence from a foreign language to English. Another workflow item may be to analyze a financial spreadsheet for fraud.

According to one embodiment of the invention, the expert accesses the workflow server 10 via his or her expert computer 22, 24. Upon recognition of the particular expert, the workflow server 10 retrieves the tasks stored in association with the logging expert and displays information about the retrieved tasks on the expert computer.

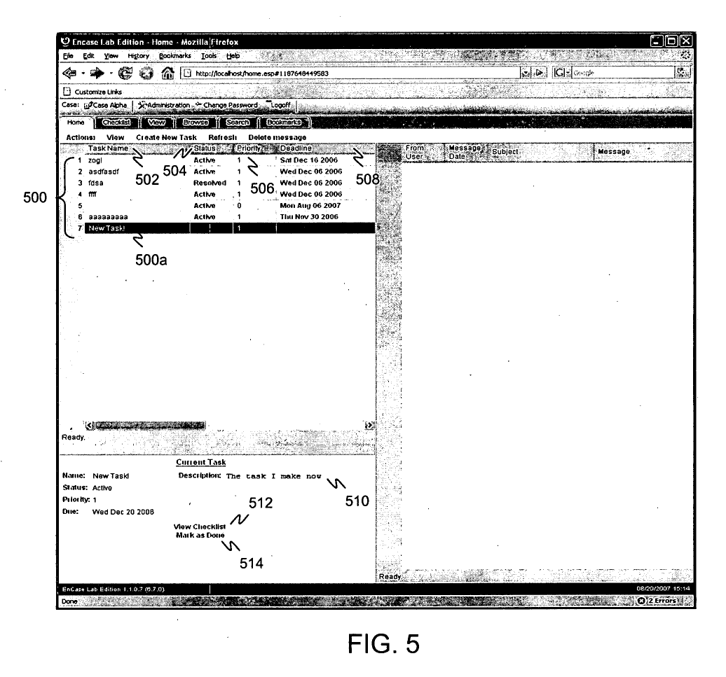

FIG. 5 is a photographic image of a screen displaying information about different tasks 500 assigned to a particular expert according to one embodiment of the invention. The task information is correlated and displayed under a task name field 502, status field 504, priority field 506, and deadline field 508. Selection of a particular task 500a provides additional information about the task, such as, for example, a task description 510 as well as one or more options that may be actuated by the expert. For example, actuation of a view checklist option 512 causes display of individual workflow items associated with the task. Actuation of a done option 514 causes change of the status of the task as being “resolved.”

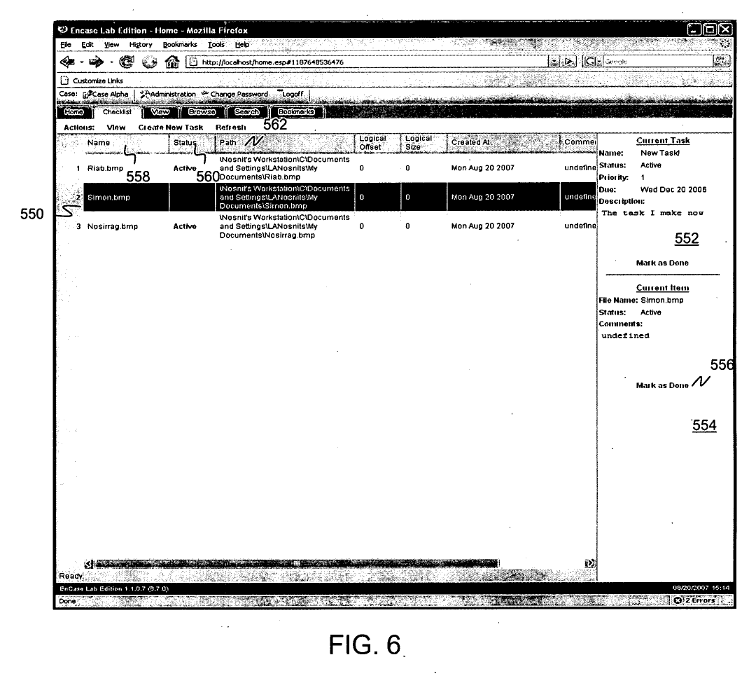

FIG. 6 is a photographic image of a plurality of workflow items assigned to a particular expert according to one embodiment of the invention. According to one embodiment, there is a one to one correspondence between a workflow item and a piece of filtered evidence associated with the task in which the workflow item is included. Thus, if a task is associated with three pieces of evidence, the workflow server generates three workflow items for the task.

Each workflow item 550 is associated with a name 558 of the filtered piece of evidence that is to be analyzed, a status of the item 560, and a path 562 in the evidence file where the particular piece of evidence is stored. Selection of a particular workflow item 550 causes display in window 552 of the task to which the workflow item belongs. More detailed information on the workflow item is also displayed in window 554. As each workflow item is completed, the expert selects a done option 556, and the status of the item 560 is changed to reflect its completion. A task is deemed to be completed when all the workflow items generated for the task have been completed.

According to one embodiment of the invention, an expert to whom a particular workflow item has been assigned takes action prompted by the workflow item by reviewing the contents of the evidence piece assigned to the workflow item. In this regard, the expert makes use of the skill set that caused him or her to be assigned to the workflow item. Upon the analysis of the contents of the evidence piece, the expert may generate an annotation on the evidence piece. In this regard, the workflow collaboration system according to various embodiments of the invention provides for a centralized creation and storage of annotations generated by different experts.

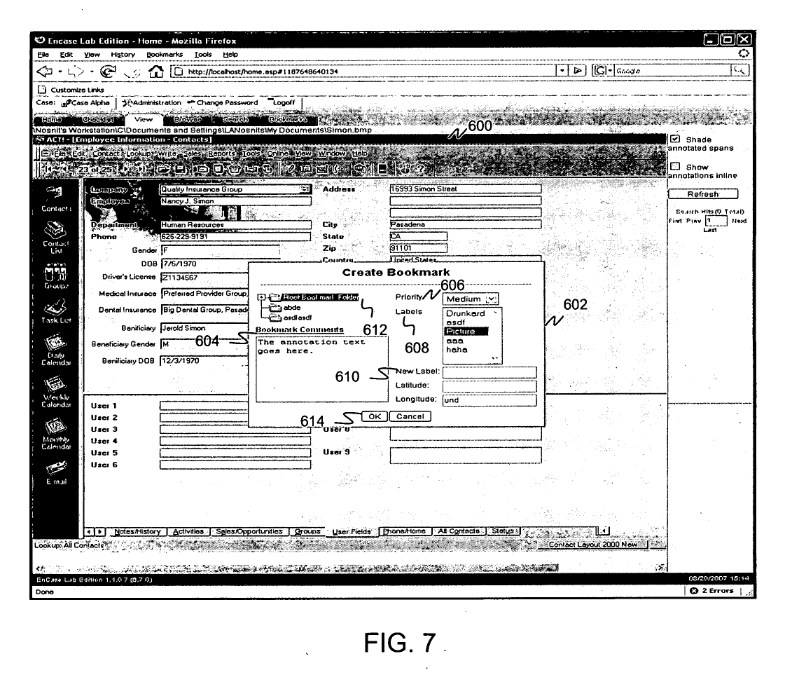

FIG. 7 is a photographic image of an annotation generated upon review of the contents 600 of an exemplary piece of evidence according to one embodiment of the invention. In the illustrated example, the evidence that is examined is a screenshot of a computer displaying an individual's contact information. Upon analysis of the evidence data, if the expert deems the piece of evidence to be useful, he or she generates annotation data for the evidence via an annotation window 602 displayed by the investigation computer 16.

According to one embodiment of the invention, the annotation window prompts 602 the expert to provide different information for the annotation that is being generated via various user input areas. For example, a comment area 604 prompts the expert to provide comments, notes, or other information about the analyzed piece of evidence. A priority field 606 prompts the expert to set a priority level 606 indicating the importance of the analyzed piece of evidence. A label field 608 prompts the expert to select one of various predefined labels for associating with the generated annotation. The expert may also generate a new label via a new label field 610. For example, the label may indicate that the annotation is a translation, financial information, or simply a notable file. According to one embodiment of the invention, the labels are used for identifying particular attributes of the annotations and/or the analyzed piece of evidence. The annotation is then submitted to the workflow server 10 upon actuation of an OK button 614.

According to another embodiment of the invention, the information that would go into the comment area 604 is provided in a separate comment document generated via a word processing application conventional in the art. In this regard, the annotation window 602 allows the selection of the generated comment document, and the document along with the labeling information is uploaded to the workflow server 10.

Upon receipt of the generated annotation including comments (or comment document), priority information, and label, the workflow server stores the annotation in the evidence database 14 in association with the analyzed piece of evidence. According to one embodiment of the invention, neither the evidence file containing the analyzed piece of evidence nor the evidence itself is modified by the generated annotation. Instead, each annotation is saved as a separate document in a bookmark folder 612 identified by the expert in the annotation window 602.

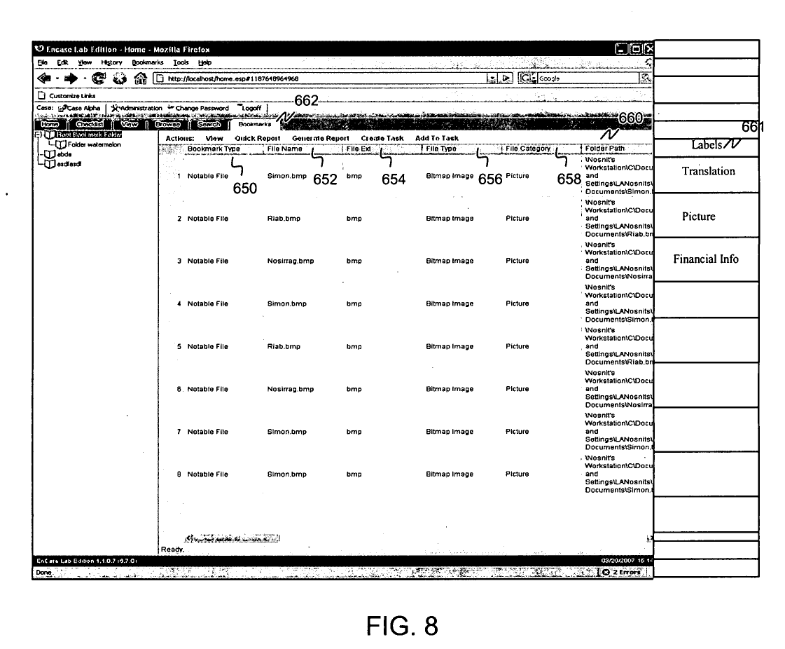

According to one embodiment of the invention, the investigation computer 16 browses the annotations stored in the evidence database 14 for generating an investigation report, or for further filtering of evidence and generating of workflow tasks. In this regard, the investigation computer 16 transmits a request to the workflow server 10 to display a list of annotations upon selection of a bookmarks tab 662 as is illustrated in FIG. 8.

FIG. 8 is a photographic image of a list of annotations stored in a bookmark folder of the evidence database 14 according to one embodiment of the invention. According to this embodiment, the type of annotation is displayed in a bookmark type column 650, the name of the evidence piece for which the annotation was generated is correlated and displayed in a file name column 652, the file extension of the evidence piece is correlated and displayed in a file extension column 654, a file type of the evidence piece is correlated and displayed in a file type column 656, a file category of the evidence piece is correlated and displayed in a file category column 658, a location in which the evidence piece was found is correlated and displayed in a folder path column 660, and the labels attached to the annotations are correlated and displayed in a labels column 661.

According to one embodiment of the invention, the annotations become part of the evidence as extensions of the analyzed pieces of evidence, and may be used for generating new tasks or uploading of further evidence. Specifically, the labels associated with the annotations provide added insight on the content of the analyzed pieces of evidence. These labels may therefore be used for further filtering of evidence and generating of additional tasks for the filtered evidence. For example, an initial filtering of the evidence for all French documents may be used to generate a task for a French translator. The French translator reviews the contents of the French documents and translates them into English. Annotations that include the English translations may then be generated for the identified French documents, and the annotations may be labeled as translations. The annotations may then be used to search for all translated documents for generating a new task to be assigned to another expert to review the contents of the translated documents. For example, a translation annotation might trigger a task assignment for an antiterrorism expert to review the translations for evidence of terrorist threats.

According to one embodiment of the invention, the annotations are also used for generating forensic reports. According to one embodiment of the invention, the labels assigned to the annotations may be used for sorting and searching for different types of useful evidence to the included into the forensic report. Information associated with the annotations such as, for example, the piece of evidence that was analyzed and the location in which such evidence was located, is stored centrally in the evidence database and correlated with the annotation for allowing the report generation to be easy and efficient.

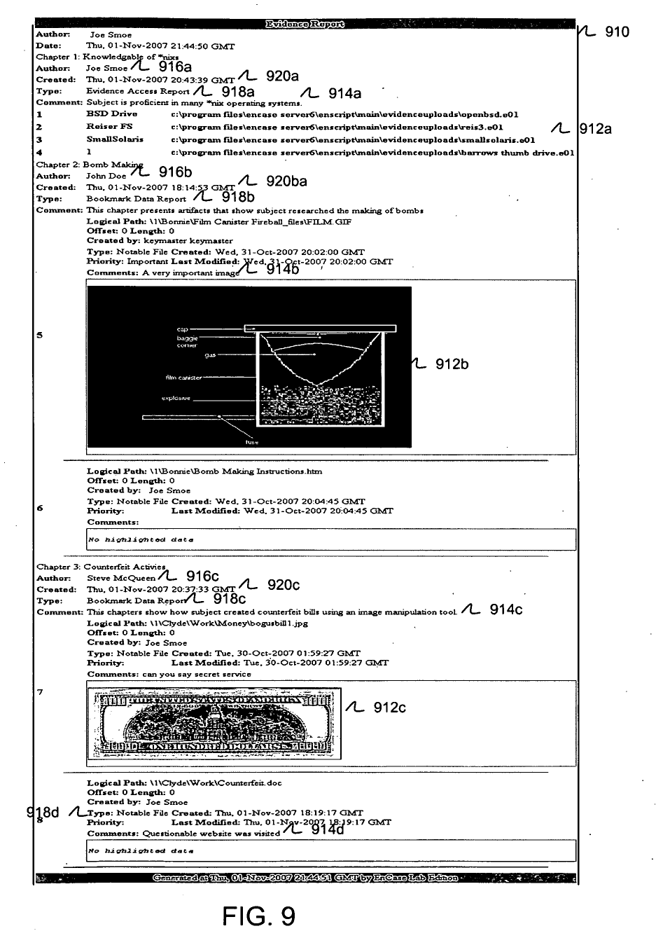

FIG. 9 is a photographic image of a forensic report 910 generated according to one embodiment of the invention. The exemplary forensic report shown in FIG. 9 include annotated file contents 912a, 912b, 912c, if any, along with associated annotation comments 914a, 914b, 914c, 914d and metadata 918a, 918b, 918c, 918d. The report may also include information on the annotating user 916a, 916b, 916c and the date of annotation 920a, 920b, 920c.

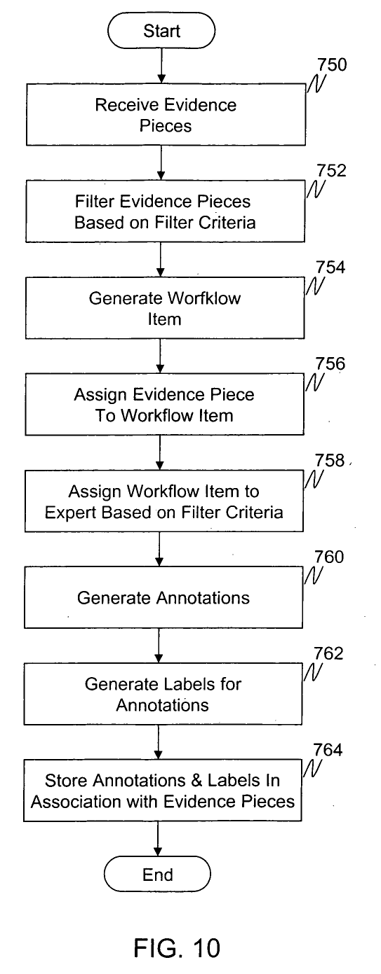

FIG. 10 is a flow diagram of a process for analyzing evidence data according to one embodiment of the invention. The process may be embodied as computer program instructions stored in a memory of the workflow server 10 and executed by a processor in the workflow server. The process may be implemented in the order indicated, or in any other order that may be apparent to a person of skill in the art.

The process begins, and in step 750, the process receives various evidence pieces that have been uploaded by the investigation computer 16. According to one embodiment of the invention, the various evidence pieces are collected into a particular evidence file and stored in the raw evidence store 30.

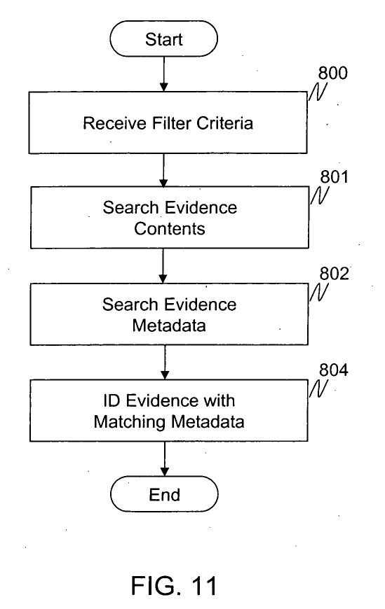

In step 752, the process receives a command to filter the evidence pieces based on a filter criteria. According to one embodiment of the invention, the filtering may be based on a manual selection of evidence pieces having a desired attribute by a user of the investigation computer 16. Alternatively, the filtering may be automatic based on the selection of the filter criteria by the user of the investigation computer 16 as is described in further detail below with respect to FIG. 11. In either embodiment, the filter criteria includes one or more attributes associated with the evidence pieces.

In step 754, the process generates a workflow item for each of the filtered evidence pieces, and in step 756 assigns each evidence piece to the workflow item. According to one embodiment of the invention, the generated workflow items are bundled into a single workflow task.

In step 758, the process assigns the workflow items to an expert based on the filter criteria. According to one embodiment of the invention, the expert may be manually selected by a user of the investigation computer 16. Alternatively, the selection may be automatic based on expert selection rules stored at the server as is described in further detail below with respect to FIG. 12.

In step 760, the process generates one or more annotations for one or more of the filtered evidence pieces based on commands and information received from the investigation computer 16. According to one embodiment, the annotations include notes, comments, or other information provided by the experts based on their review of the contents of the pieces of evidence.

In step 762, the process generates one or more labels for the one or more annotations based on commands and information received from the investigation computer 16.

In step 764, the process stores the generated annotations and labels in association with the analyzed evidence piece.

FIG. 11 is a more detailed flow diagram of a process for filtering evidence pieces based on specific filter criteria according to one embodiment of the invention. The process starts, and in step 800, receives a filter request from the investigation computer 16 along with the filter criteria to be used to filter the pieces of evidence. For example, the filter criteria may specify one or more file extensions, file categories, file locations, hash values, or some other attribute stored in association with the analyzed pieces of evidence. In step 801, the process optionally proceeds to search the contents of the evidence pieces for the indicated filter criteria. This step can optionally take advantage of a pre-generated evidence content index.

In step 802, the process proceeds to search the metadata associated with the evidence pieces for the indicated filter criteria.

In step 804, the process identifies the evidence pieces that have metadata that satisfies the filter criteria. In this regard, the process may display all the evidence pieces stored in a particular evidence file with the evidence pieces that have the matching metadata automatically highlighted. Alternatively, the matching evidence pieces may be filtered into a separate list.

FIG. 12 is a more detailed flow diagram of a process for assigning workflow items to an expert according to one embodiment of the invention. The process starts, and in step 850, identifies an evidence attribute. The attribute may be, for example, part of the filter criteria used to filter an evidence data set.

In step 852, the process identifies and retrieves an expert list associated with the filter criteria. In this regard, the workflow server 10 maintains a separate expert list for each attribute that may be used as a filter criteria to filter evidence. Each expert list may include identification information of one or more experts whose skill sets are commensurate with the associated attribute. Other information about the experts may also be maintained in the expert list, such as, for example, the status of tasks assigned to the experts.

In step 854, the process automatically selects an expert from the expert list. The selection may be based on a selection rule that takes into account the number of tasks assigned to the experts in the list, the status of those tasks, and the like. Alternatively, the selection rule may cause a random selection of an expert from the list, or the selection of an expert according to a round robin scheduling mechanism.

Once the expert is selected, the process may optionally request the user of the investigation computer 16 to confirm the selection of the expert in step 856.

### II. Automatic Task Generation Module

The embodiments described above contemplate the generation of tasks in response to specific user actions that cause the generating of tasks based on either manual or automatic filtering of evidence pieces. The user action contemplated for the generating of the tasks is, for example, the selection of the “create task” button 414 or “add to task” button 416, and the manual filling of at least some information in the task window 400 (FIG. 4).

According to another embodiment of the invention, the workflow server 10 includes an automatic task generation module that generates tasks automatically in response to evidence processing, even in the absence of the specific user actions. The automatic task generation module may be a software module that is executed by the processor in the workflow server according to computer program instructions stored in memory. A person of skill in the art should recognize that the automatic task generation module may also be implemented, as appropriate, via hardware, firmware, or a combination of hardware, firmware, and/or software.

According to one embodiment of the invention, the automatic task generation module provides an interface that allows a user of the investigation computer 16 to specify rules that indicate one or more triggers that will cause the automatic generating of a new task, and one or more filter criteria to be used to filter the evidence pieces to be assigned to the new task. The trigger may be identification of a particular attribute associated with a processed piece of evidence. The trigger may further be the creation of an annotation, or the creation of an annotation having a particular label. In other embodiments, the trigger may be the generation of a report, completion of a workflow item without generation of an annotation on the same evidence piece, creation of an annotation with a particular set of metadata (such as GPS coordinates), or similarity of evidence piece contents to a previously-annotated piece of evidence.

The pieces of evidence to be associated with the new task are identified by filtering one or more evidence files based on the identified filter criteria. The filter criteria may include the same attribute as the attribute specified as the trigger, or include an attribute other than the attribute specified as the trigger. According to one embodiment of the invention, the identification of the expert to whom the new task is to be assigned is automatically selected based on the filter criteria in a manner similar to the manner described above with respect to FIG. 12.

According to one embodiment of the invention, a user specifies a task generation rule that causes the automatic task generation module to monitor the evidence database 14 or some other third party database, for evidence having a particular attribute. The rule may be automatically invoked each time the monitored database is populated with new information, or periodically invoked based on a predefined schedule.

The particular attribute to be monitored may be defined by the user at a conceptual level (e.g. all “pictures”), and the module may be configured to identify specific attributes associated with the concept (e.g. “bmp,” “jpeg,” etc.). The module may then monitor the database for new evidence having the specific attributes. According to one embodiment of the invention, adding a new piece of evidence into a monitored database with the particular attribute triggers a specific task generation rule which creates a new task for the new piece of evidence. The new task causes the analysis of the new piece of evidence by an expert selected based on the invoked task generation rule.

According to another embodiment of the invention, the specific task generation rule sets as the filter criteria the particular attribute that triggered the generation of the new task. The filter criteria is then used for identifying all other pieces of evidence (other than the new piece of evidence) that have the particular attribute. A workflow item may then be generated for each of the other filtered pieces of evidence, and assigned to an expert associated with the filter criteria for analysis.

According to yet another embodiment, the task generation rule may specify that each time an annotation is generated as a result of evidence processing, and that annotation has a particular label, to automatically filter the remaining evidence files for pieces of evidence that have a same attribute as the attribute of the particular piece of evidence that was processed. In this regard, the filter criteria identified by the task generation rule is the attribute of the processed piece of evidence. Alternatively, the rule may specify as the filter criteria an attribute different than the attribute of the processed piece of evidence.

The task generation rule according this embodiment further causes the automatic generating of a task and assigning of the task to the same (or different) expert that analyzed the particular piece of evidence. The automatically generated task contains a workflow item for each piece of evidence that was filtered based on the filter criteria identified by the task generation rule. For example, the particular piece of evidence may be a foreign document that is analyzed for generating a translation of the document into English. The translation is stored as an annotation, and assigned a label to identify it as a translation. The generating of the annotation having the translation label triggers a specific task generation rule. The task generation rule may set as the filter criteria the hash value of the analyzed piece of evidence to find all other pieces of evidence having the same hash value. A workflow task is generated for each identified piece of evidence and assigned to the same expert that generated the translation to determine, for example, if the identified piece of evidence has the same content as the initially analyzed piece of evidence.

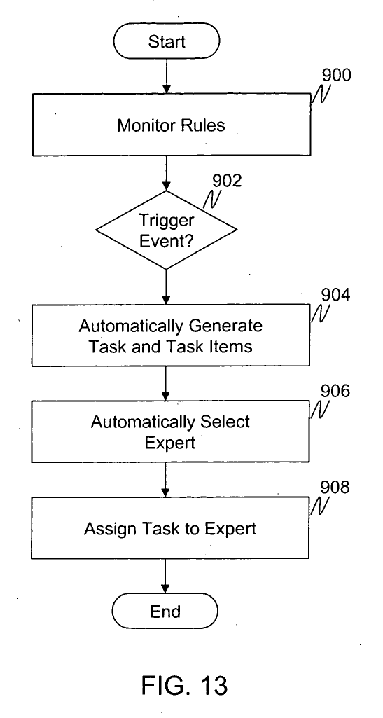

FIG. 13 is a flow diagram of a process executed by the automatic task generation module for automatically generating tasks according to one embodiment of the invention. The process starts, and in step 900, the module monitors one or more task generation rules for a specified trigger event. According to one embodiment of the invention, the trigger event is generated from the processing of one or more evidence pieces. For example, the processing may be reviewing attributes associated with the evidence pieces, and the trigger may be detection of an attribute specified by one of the monitored rules. According to another example, the processing may be analyzing contents of the one or more evidence pieces and generating annotations for the analyzed evidence pieces, and the trigger may be the generation of an annotation having a label (also referred to as an attribute) specified by one of the monitored rules.

In step 902, a determination is made as to whether a particular trigger event has been detected. If the answer is YES, the module, in step 904, proceeds to automatically generate a workflow task and one or more workflow items for the task. In generating the workflow items, the module retrieves from the task generation rule that triggered the generating of the new task, the filter criteria to be used for filtering the evidence pieces in the evidence database 14. The module filters the evidence pieces and generates a workflow item for each filtered evidence piece.

In step 906, the module automatically selects an expert for the newly generated task. In this regard, the module identifies a group of experts associated with the filter criteria, and selects a particular expert from the identified group. The invoked task generation rule may also specify other criteria for selecting the expert. For example, the invoked rule may indicate that the new task should be assigned to the same expert that analyzed a triggering piece of evidence.

In step 908, the new task is assigned to the selected expert.

According to another embodiment of the invention, instead of generating a new task in response to the trigger event, the module identifies a related existing task that has not yet been fulfilled, and assigns one or more workflow items to the existing task. The task identification may be based on the trigger event and the trigger used to create the existing task, or on the size of the existing task, or other parameters. For example, a task with a small number of workflow items might be targeted, or an existing task generated by the same trigger might be selected.

Although this invention has been described in certain specific embodiments, those skilled in the art will have no difficulty devising variations to the described embodiment which in no way depart from the scope and spirit of the present invention. Furthermore, to those skilled in the various arts, the invention itself herein will suggest solutions to other tasks and adaptations for other applications. It is the Applicant's intention to cover by claims all such uses of the invention and those changes and modifications which could be made to the embodiments of the invention herein chosen for the purpose of disclosure without departing from the spirit and scope of the invention. Thus, the present embodiments of the invention should be considered in all respects as illustrative and not restrictive, the scope of the invention to be indicated by the appended claims and their equivalents rather than the foregoing description.

What is claimed is:

1. A computer-implemented method for analyzing forensic evidence data, the method comprising:
receiving a plurality of evidence pieces, wherein each of the plurality of evidence pieces has a plurality of attributes stored in association with the evidence piece;
filtering the plurality of evidence pieces based on a filter criteria, wherein the filter criteria includes one or more of the plurality of the attributes;
receiving a first user command for the filtered evidence pieces;
generating a separate workflow item for each of the filtered evidence pieces in response to the first user command;
receiving a second user command for the workflow items;
identifying an expert based on the second user command, the identified expert having abilities commensurate with the filter criteria; and
assigning each of the workflow items to the expert for prompting analysis of contents of the filtered evidence pieces.

2. The method of claim 1, wherein the attributes are metadata information.

3. The method of claim 1, wherein the filtering of the evidence pieces does not invoke examination of contents of the evidence pieces.

4. The method of claim 1, wherein the assigning includes:
maintaining an expert list in association with each of the plurality of attributes;
identifying the expert list associated with the filter criteria; and
identifying a person from the expert list.

5. The method of claim 1 further comprising:
generating annotations for one or more of the filtered evidence pieces for which a workflow item has been generated;
generating labels for the annotations; and
storing the annotations and the labels in association with the one or more of the filtered evidence pieces.

6. The method of claim 5, wherein the annotations include notes generated based on the analysis of the contents of the one or more of the filtered evidence pieces.

7. The method of claim 5 further comprising:
filtering the plurality of evidence pieces based on a second filter criteria for generating second filtered evidence pieces, wherein the second filter criteria includes one or more of the labels generated for the annotations;
generating a second workflow item for each of the second filtered evidence pieces; and
assigning each of the generated second workflow items to a second expert selected based on the second filter criteria for prompting analysis of the contents of the corresponding second filtered evidence pieces.

8. The method of claim 1 further comprising:
identifying one or more of the annotations based on the associated labels; and
generating a report based on the identified annotations.

9. The method of claim 1 further comprising:
tracking status of each of the workflow items; and
displaying the status on a user display.

10. A server for analyzing forensic evidence data, the server comprising:
a processor; and
a memory operably coupled to the processor and having program instructions stored therein, the processor being operable to execute the program instructions, the program instructions including:
receiving a plurality of evidence pieces, wherein each of the plurality of evidence pieces has a plurality of attributes stored in association with the evidence piece;
filtering the plurality of evidence pieces based on a filter criteria, wherein the filter criteria includes one or more of the plurality of the attributes;
receiving a first user command for the filtered evidence pieces;
generating a separate workflow item for each of the filtered evidence pieces in response to the first user command;
receiving a second user command for the workflow items;
identifying an expert based on the second user command, the identified expert having abilities commensurate with the filter criteria; and
assigning each of the workflow items to the expert for prompting analysis of contents of the filtered evidence pieces.

11. A computer-implemented method for automatic workflow task generation in a forensic investigation system, the method comprising:
processing a piece of evidence;
generating a trigger event based on the processing of the piece of evidence;
automatically invoking a rule set based on the generated trigger event;
automatically selecting, without user intervention, one or more evidence pieces based on the invoked rule set;
automatically generating, without user intervention, a separate workflow item for each of the one or more of the evidence pieces;
automatically selecting, without user intervention, an expert based on the invoked rule set; and
automatically assigning, without user intervention, each of the generated workflow items to the selected expert.

12. The method of claim 11, wherein the piece of evidence is associated with a plurality of attributes, the processing including reviewing the plurality of attributes stored in association with the piece of evidence, and wherein the trigger is identification of a particular one of the plurality of attributes.

13. The method of claim 12, wherein the one or more evidence pieces includes the processed piece of evidence.

14. The method of claim 12, wherein the one or more evidence pieces includes evidence pieces other than the processed piece of evidence.

15. The method of claim 12, wherein the automatically selecting an expert includes:
maintaining an expert list in association with each of the plurality of attributes;
identifying the expert list associated with the particular one of the plurality of attributes; and
identifying an expert from the expert list.

16. The method of claim 15, wherein the identified expert has abilities commensurate with the filter criteria.

17. The method of claim 11, wherein the processing of the piece of evidence includes:
generating an annotation for the piece of evidence; and
generating a label for the annotation, wherein the trigger event is the generating of the annotation having the label.

18. The method of claim 17, wherein the rule set identifies a filter criteria, and the automatically selecting the one or more evidence pieces is based on the filter criteria.

19. The method of claim 18, wherein the filter criteria identifies one or more of a plurality of attributes associated with the one or more other evidence pieces.

20. The method of claim 19, wherein the automatically selecting an expert includes:
maintaining an expert list in association with each of the plurality of attributes;
identifying the expert list associated with the filter criteria; and
identifying an expert from the expert list.

21. The method of claim 20, wherein the identified expert has abilities commensurate with the filter criteria.

22. The method of claim 11, wherein the automatically selecting does not invoke examination of contents of the one or more other evidence pieces.
